(19) United States
(12) Patent Application Publication
(10) Pub. No.: US 2006/0217984 A1
(43) Pub. Date: Sep. 28, 2006

(54) Critical band additive synthesis of tonal audio signals

(76) Inventor: Eric Lindemann, Boulder, CO (US)

Correspondence Address: JENNIFER L. BALES, MOUNTAIN VIEW PLAZA, 1520 EUCLID CIRCLE, LAFAYETTE, CO, 80026-1250, US

(21) Appl. No.: 11/334,014

(22) Filed: Jan. 18, 2006

Related U.S. Application Data
(60) Provisional application No. 60/664,598, filed on Mar. 23, 2005.

(51) Int. Cl. G10L 13/06

(52) U.S. Cl. 704/268

(57) ABSTRACT

An efficient synthesizer of tonal audio signals is disclosed. The tonal audio signal synthesizer utilizes additive synthesis of harmonics of the base frequency. Rather than generating and summing all of the individual frequency sinusoidal harmonics as in traditional additive synthesis, critical band signals (comprising multiple harmonics added together) are generated, and the critical bands are summed based upon the Critical Bands resolvable by human hearing. Each critical band signal comprises the combination of from one to many sinusoids, generally of equal amplitude. Generally only a single harmonic is included in the lowest critical band, or the lowest several critical bands. As the frequency increases, the number of harmonics in each critical band increases as well. A gain is applied to each critical band signal.

This application claims the benefit of U.S. Provisional Application No. 60/664,598 filed Jan. 18, 2004, and incorporates it herein by reference. U.S. Pat. No. 6,298,322, issued Oct. 2, 2001 to the present inventor and entitled “Encoding and Synthesis of Tonal Audio Signals Using Dominant Sinusoids and a Vector-Quantized Residual Tonal Signal,” is incorporated herein by reference.

### FIELD OF THE INVENTION

This invention relates to efficient additive synthesis of tonal audio signals. In particular, the invention relates to critical band additive synthesis of tonal audio signals in a music synthesis system.

### BACKGROUND OF THE INVENTION

Tonal sounds can be effectively modeled as a sum of sinusoids with time-varying parameters consisting of frequency, amplitude, and phase. The key word here is “effectively” because, in fact, all sounds can be modeled as sums of sinusoids, but the number of sinusoids may be extremely large, and the time-varying sinusoidal parameters may not have intuitive significance. Colored noise signals like breath noise, ocean waves, and snare drums are examples of sounds that are not effectively modeled by sums of sinusoids. Pitched musical instruments such as clarinet, trumpet, gongs, and certain cymbals, as well as ensembles of these instruments are examples of tonal sounds that are effectively modeled as sums of sinusoids.

Many sounds are modeled as a combination of tonal and non-tonal, or colored noise, sounds. Flute and violin both have tonal and colored noise components. Human speech is often modeled as a mixture of tonal or “voiced” speech, and colored noise or “unvoiced” speech. The present invention is concerned with encoding and synthesizing tonal audio signals. This invention can be used in conjunction with systems for encoding and synthesizing non-tonal or colored noise signals.

Pitched signals are a special class of tonal audio signals in which the sinusoidal frequencies are harmonically related. The present invention can be used for encoding and synthesizing both pitched and unpitched tonal audio signals, but is most useful and efficient for pitched signals. Specifically optimized embodiments are proposed for encoding and synthesizing pitched tonal audio signals.

One method of synthesizing tonal audio signals is additive sinusoidal synthesis. This method provides excellent results since the synthesis model is the same model as the signal: a sum of sinusoids with time-varying parameters. U.S. Pat. Nos. 4,885,790 and 4,937,873, both to McCauley et. al, and U.S. Pat. No. 4,856,068, to Quatieri, J R. et al., teach systems for encoding and synthesizing sound waveforms as a sums of sinusoids with time-varying amplitude, frequency, and phase. FIG. 1 (Prior Art) shows a simplified example of such a system. While sinusoidal encoding and synthesis provides excellent results for tonal audio signals, the synthesis requires large computational resources because many tonal audio signals may involve one hundred or more individual sinusoids.

To reduce the computational requirement of sinusoidal synthesis U.S. Pat. No. 5,401,897 to Depalle et al., U.S. Pat. No. 5,686,683, to Freed, and U.S. Pat. No. 5,327,518 teach systems for sinusoidal synthesis using Inverse Fast Fourier Transform (IFFT) techniques. While this approach reduces somewhat the computation requirements for synthesis of a large number of parameters, the computation is still expensive and new problems are introduced. Many synthesis environments, for example musical synthesizers, require multi-channel output. Using IFFT approaches, a separate IFFT system must be used for every channel. In addition, IFFT systems limit sinusoidal parameter update to once per frame, where a frame length must be at least as long as the lowest frequency period. This parameter update rate may be insufficient at higher frequencies.

U.S. Pat. Nos. 5,581,656, 5,195,166, and 5,226,108, all to Hardwick et al., teach a system where a certain number of sinusoids, the dominant or low-frequency sinusoids, are synthesized using traditional time-domain sinusoidal additive synthesis, while the remaining sinusoids are synthesized using an IFFT approach. This permits higher update rate for the dominant sinusoid components while taking advantage of the lower IFFT computation rate for the bulk of the sinusoids. This approach has the disadvantages of IFFT computation cost especially with multi-channel synthesis. In addition, the dominant sinusoid components are usually at lower frequencies and it is the higher that often require an increased parameter update rate.

A number of less compute-intensive systems have been proposed for encoding and synthesizing tonal audio signals. Linear Predictive Coding (LPC) is well known in the art of speech coding and synthesis. Methods for using LPC for synthesizing tonal or voiced speech concentrate on methods for generating the tonal excitation signal. The numerous approaches include, generating a pulse-train at the desired pitch, generating a multi-pulse excitation signal at the desired pitch, vector quantizing (VQ) the excitation signal, and simply transmitting the excitation signal with fewer bits. U.S. Pat. No. 5,744,742, to Lindemann et al., teaches a system for encoding excitation signals as single pitch period loops. To synthesize excitation signals at different pitches or amplitudes, weighted sums of pitch period excitation signal loops are created. The excitation signal pitch periods are stored in single pitch period waveform memory tables. The phase response of all excitation signal waveforms is forced to be the same so that weighted sums of the waveforms do not cause phase cancellation. All of these techniques with the exception of simply transmitting the excitation signal give poorer results than full additive sinusoidal encoding and synthesis. The pulse based techniques in particular sound “buzzy” and unnatural.

U.S. Pat. No. 5,369,730 to Yajima, U.S. Pat. No. 5,479,564 to Vogten et al., European Patent 813,184 A1 to Dutoit et al., European Patents 0,363,233A1 and 0,363,233B1, both to Hamon, teach methods of pitch synchronous concatenated waveform encoding and synthesis. With this method a number of single pitch period waveforms are stored in memory. To synthesize a time-varying signal, a sequence of single pitch period waveforms is selected from waveform memory and concatenated over time. The waveforms are usually overlap-added for continuity. To shift the pitch of the synthesized signal the overlap rate is modulated. While relatively inexpensive in terms of compute resources, this approach suffers from distortions especially associated with the pitch shifting mechanism. Is audibly inferior to full additive synthesis for most tonal audio signals.

Other methods for reducing the computational load of additive synthesis of tonal audio synthesis have attempted to represent a whole range of sounds with only a few (3-5) tables. For example, Multiple Wavetable Synthesis represents different timbres (like specific vowel sounds with a few tables. See, for example, “Methods for Multiple Wavetable Syntheisi of Musical Instrument Tones,” Horner et al., J. Audio Eng. Soc., Vol 41, No. 5, 1993 May, pp 336-356. Group Additive Synthesis uses 3-5 tables to represent partials of a tone. See for example. “Analytical Methods for Group Additive Synthesis,” Oates et al., Computer Music Journal, 21:2, pp. 21-39, Summer 1997. Both of these methods pursue elaborate, instrument specific techniques to find a minimal set of tables.

Both Multiple Wavetable Synthesis and Group Additive Synthesis suffer from the same drawbacks. First, 3-5 tables are not sufficient to sound genuine to the human ear. Human hearing can resolve around 24 frequency bands (called Critical Bands) of sound, and expects to hear differences (for example, in gain envelopes) between the critical bands. At the same time, Multiple Wavetable Synthesis and Group Additive Synthesis require separate sets of tables for each instrument. These techniques cannot take advantage of using the same tables for a variety of instruments and sounds, and so do not operate as efficiently as possible.

A need remains in the art for improved methods and apparatus for additive synthesis of tonal sounds, which retain sound quality but require fewer parameters and reduce computational requirements.

### SUMMARY OF THE INVENTION

Accordingly, an object of the present invention is to provide improved methods and apparatus for additive synthesis of tonal audio signals, which retain sound quality but require fewer parameters and reduce computational requirements.

The present invention assumes a tonal audio signal that can be represented as a sum of sinusoids of time-varying frequency, amplitude, and phase. Many tonal sounds of interest are pitched. These can be represented as a sum of harmonically related sinusoids.

From the field of psychoacoustics, it is understood that the human ear functions in like a bank of highly overlapped bandpass filters. The output of each bandpass filter is rectified and indicates to the brain the loudness in each bandpass filter frequency band. Below 500 Hz the bandpass filters are all approximately 100 Hz wide. Above 500 Hz the bandpass filters are approximately f_{c}/5 where f_{c} is the center frequency of the bandpass filter so the frequency bands become progressively wide at higher center frequencies. These bands are called “critical bands.” Since the brain receives frequency dependent loudness from the output of the critical band filters if a number of harmonic components, or sinusoidal pure tones, fall within the same critical band the brain is largely insensitive to relative changes of amplitude in these tones as long as the overall loudness or power across the critical band is unchanged. In this sense the ear and brain have less frequency resolving ability at higher frequencies.

Human hearing (the combination of the ear and the brain's interpretation of the ear's response) can resolve right around 24 Critical Bands, expects to hear differences between these critical bands. If critical bands are merged, the result is artificial sounding. On the other hand, there is no point to providing variations within critical bands, as human hearing will not distinguish it. Therefore, the present invention provides bands attuned to human psychoacoustics—ideally right around 24 bands, but certainly within the range of 8-50 bands.

The present invention takes advantage of this “Critical Band” aspect of human hearing to group higher harmonics together into critical bands and apply a single gain to the entire critical band group. Note that “harmonics,” as used in this application, refers not just to integer multiples of base frequencies, but also to non-integer multiples of base frequencies.

In other words, rather than generating and summing all of the individual harmonic sinusoids as in traditional additive synthesis, critical band signals (comprising multiple sinusoids at higher frequencies) are generated and these critical band signals are summed. Each critical band signal comprises the combination of from one to several sinusoids of equal amplitude. A gain is applied to each critical band signal.

In one preferred embodiment of the present invention, only a single harmonic is included in the lowest critical band, or the lowest several critical bands. As the frequency increases, the number of harmonics in each critical band increases as well. For the example of pitched signals, given a base frequency of f₀, a component of each integer multiple of f0 will form part of the output signal. f₁ is 2f₀, f₂ is 3f₀, etc. These are the harmonics. For example, for lowest harmonic f₀, as well as harmonics f₁-f₇, each harmonic would get its own critical band. Harmonics f₈ and f₉ would be grouped in one critical band.

The present invention generally utilizes waveform tables (such as table lookup oscillators), wherein the waveform for each critical band is stored in memory. The table outputs samples according to a control signal. The waveform tables have frequency bands of increasing bandwidth as frequency increases, with multiple harmonics within a band summed and a single gain applied. In some cases the lowest few harmonics may be generated by function generators (e.g. feedback oscillators), since they comprise only one or a few combined harmonics.

In one preferred embodiment, a single current phase position and phase increment is used for all frequency bands. Identical table lengths are also used. This is a particularly efficient embodiment for vector processing.

Different current phases and phase increments applied to different frequency bands allows for initial phase randomization, detuning and non-pitched tonal sounds. Generally, the harmonics within a single frequency band have equal amplitudes, but this can vary if desired. For example, frequency bands may overlap—the same harmonic may appear in more than one band—and such repeated harmonics would probably be scaled down. Or, higher frequency harmonics within a frequency band might have lower amplitude.

Embodiments that save memory include the use of different length tables and the use of a single table for more than one frequency band (using different phase increments).

An embodiment that is particularly efficient in terms of processing power interleaves the entries in the frequency band tables, so that, for example, 24 samples in a row may be read out, rather than skipping around in memory.

### BRIEF DESCRIPTION OF THE DRAWINGS

FIG. 1 (Prior Art) is a block diagram illustrating a conventional harmonic additive synthesizer.

FIG. 2 is a block diagram showing a first embodiment of a sound synthesizing system utilizing the critical band tonal additive synthesizer of the present invention.

FIG. 3 is a flow diagram showing a first embodiment of a critical band tonal synthesizer according to the present invention.

FIGS. 4A-4H are waveforms stored in subbands for exemplary embodiments of the present invention.

FIG. 5 is a block diagram illustrating the table lookup/function generator portion of a second embodiment of the additive synthesizer of the present invention.

FIG. 6 is a block diagram illustrating the table lookup/function generator portion of a third embodiment of the additive synthesizer of the present invention.

FIG. 7 is a block diagram illustrating the table lookup/function generator portion of a fourth embodiment of the additive synthesizer of the present invention.

FIG. 8 is a block diagram illustrating the table lookup/function generator portion of a fifth embodiment of the additive synthesizer of the present invention.

### DETAILED DESCRIPTION OF THE INVENTION

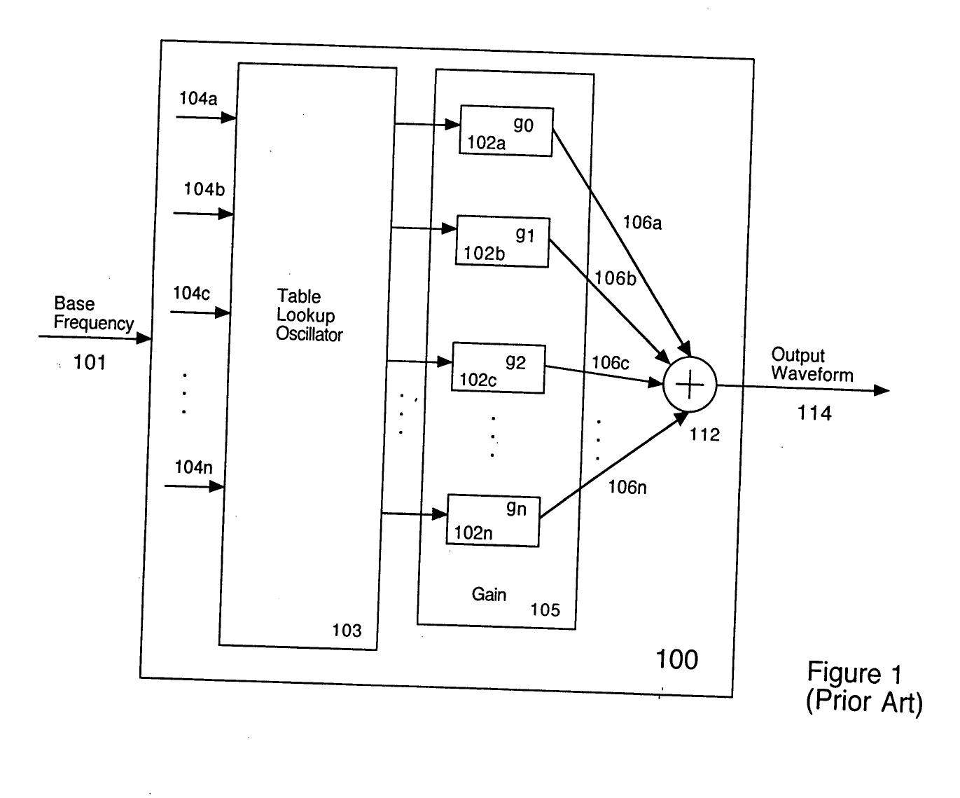

FIG. 1 (Prior Art) is a block diagram illustrating an example of a conventional harmonic additive synthesizer 100. The method applied by additive synthesizer 100, synthesizing tonal audio signals by additive sinusoidal synthesis, provides excellent results since the synthesis model is the same model as the signal: a sum of sinusoids with time-varying parameters. Given a fundamental input frequency f₀, additive synthesizer 100 generates harmonics 106 at integer multiples of f₀, up to a designated top frequency generally corresponding with the limits of human hearing. 2f₀ is designated f₁, 3f₀ is designated f₂, etc. Each harmonic 106 is generated by a table lookup oscillator 103, and has a gain 102 (applied by gain block 105. Harmonics 106 are combined by adder 112 to form output signal 114. Associated with each table lookup oscillator is a current phase 104 that indicates the current location in the table. A phase increment indicates the amount that the current phase is incremented after each sample is fetched from the lookup table. At the beginning of tone generation the current phase is set to an initial phase value. The initial phase value may be randomized across harmonics to avoid an overly peaked waveform and to minimize a “buzzy” sound associated sums of in phase harmonics. While this method of sinusoidal synthesis provides excellent results for tonal audio signals, the synthesis requires large computational resources because many tonal audio signals may involve hundreds of individual sinusoids.

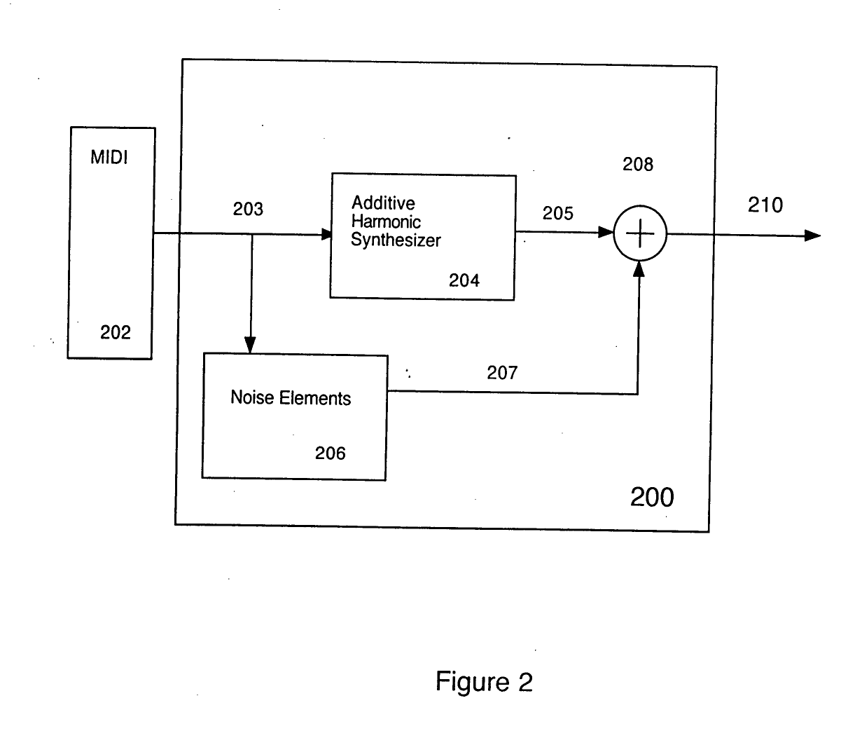

FIG. 2 is a simplified block diagram showing an example of a sound synthesizing system 200 utilizing the critical band tonal synthesizer of the present invention One or more MIDI channels 203 are provided by MIDI controller 202. Each channel includes a stream of note data including pitch, velocity, note duration, volume, etc. Synthesizer 200 divides the data between tonal sounds, handled by the additive harmonic synthesizer 204, and noise elements 206. There are two types of noise elements: transient noises associated with attacks and note transitions, and sustain noises such as breath or bow noise. Some synthesizers omit noise elements altogether and form all sounds with sinusoids. Combiner 208 combines the tonal elements and the noise elements to generate output sound signal 210.

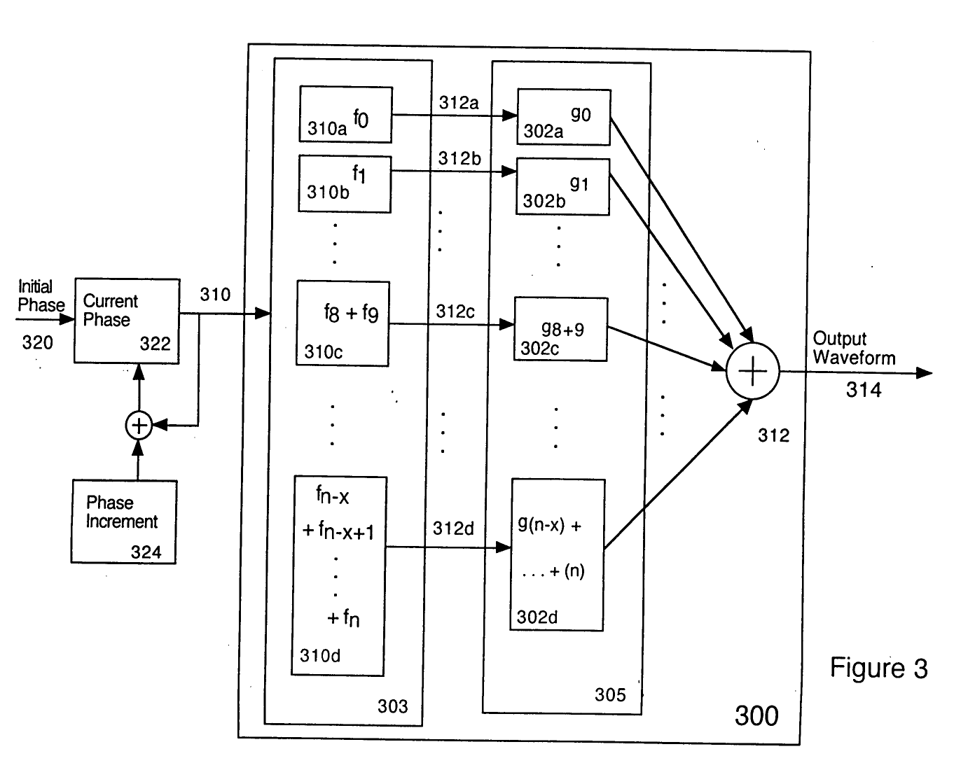

FIG. 3 is a flow diagram showing a first embodiment of a critical band tonal synthesizer 204 according to the present invention. This critical band tonal synthesizer generates the tonal sounds of Synthesizer 200 described above. The embodiment of FIG. 3 is best suited for modeling pitched tonal sounds. A single current phase value 322 is initialized with a single initial phase 320 and incremented by a single phase increment 324. The single current phase 322 is used as an offset into a bank of table lookup oscillators 310. This embodiment is especially efficient for vector processing. Modern CPUs often support efficient vector processing including fetching and calculating multiple values in parallel as long as those values are stored efficiently in memory. Preferably, additive synthesizer 204 interleaves the entries in the tables 310, so that many samples in a row (one from each table in turn) may be read out, rather than skipping around in memory.

Critical band tonal synthesizer 300 takes advantage of the critical band nature of human hearing to group higher frequency harmonics together into a single critical band table 310 and apply a single gain 302 to the entire group. In other words, rather than generating individual sinusoids as in the traditional additive synthesis of FIG. 1, sine signals within a critical band are summed to form a single critical band waveform table that is treated as a single table lookup oscillator. Each critical band waveform comprises from one to many sinusoids, generally of equal amplitude. A gain is applied to each critical band signal 312. This grouping of sinusoids into critical bands accounts for the efficiency of the present invention. Randomization of initial phase is achieved by storing the sinusoids and sums of sinusoids in the lookup tables 310 at different phases.

Note that given a base frequency of f₀, a component of each integer multiple of f₀ will form part of the output signal. f₁, is 2f₀, f₂ is 3f₀, etc. These are the harmonics. In the embodiment of FIG. 3, only a single harmonic is included in the lowest several critical bands 310, in this example f₀ through f₇. Each harmonic thus gets its own critical band 310, and signals 312 are sinusoidal. As the frequency increases, the number of harmonics in each critical band increases as well. So f8 and f9 are combined additively in critical band table 310c, and form a combined signal 312c. As frequency approaches the higher end of human hearing, more harmonics are combined in a single critical band table 310. The top critical band, 310d, might comprise a waveform combining on the order of 60 harmonics all controlled by a single gain 302d.

Input signal 301 is the control signal that indicates which sample should be read from each critical band table. Signal 301 is essentially an offset which is based upon the initial phase 320 and the phase increment 324, which are combined to generate current phase 322. The base frequency f₀ is used to determine the phase increment required—a higher frequency will require stepping through the tables faster. The same offset 301 is applied to every critical band waveform 310. So, for example, the offset might be a fractional pointer (called current phase) that gives the current offset in ALL the critical band waveform tables. For example the offset 301 might be a fractional pointer at 2.353. Any number of interpolation or rounding schemes could be used to determine the value, generally between the value of sample 2 and the value of sample 3, which is applied. Then, to get the next value (the next sample) we increment by phase increment 324, which is determined by f₀ (the frequency or pitch of the note)—e.g. 1.288. Phase increment 324 is the inverse of f₀ (normalized by sampling rate etc.). So the next fractional pointer 301 is 3.641 (3.641=2.353+1.288), and we take a value generally interpolated between the value at location 3 and the value at location 4 in all the tables. If the phase increment 1.288 is bigger, this gives us a higher f₀ and if it's smaller this gives us a lower f₀ (lower pitch for the note). When the fractional pointer 301 is greater than the length of table 310, it wraps around: fractional pointer=fractional pointer−length of table.

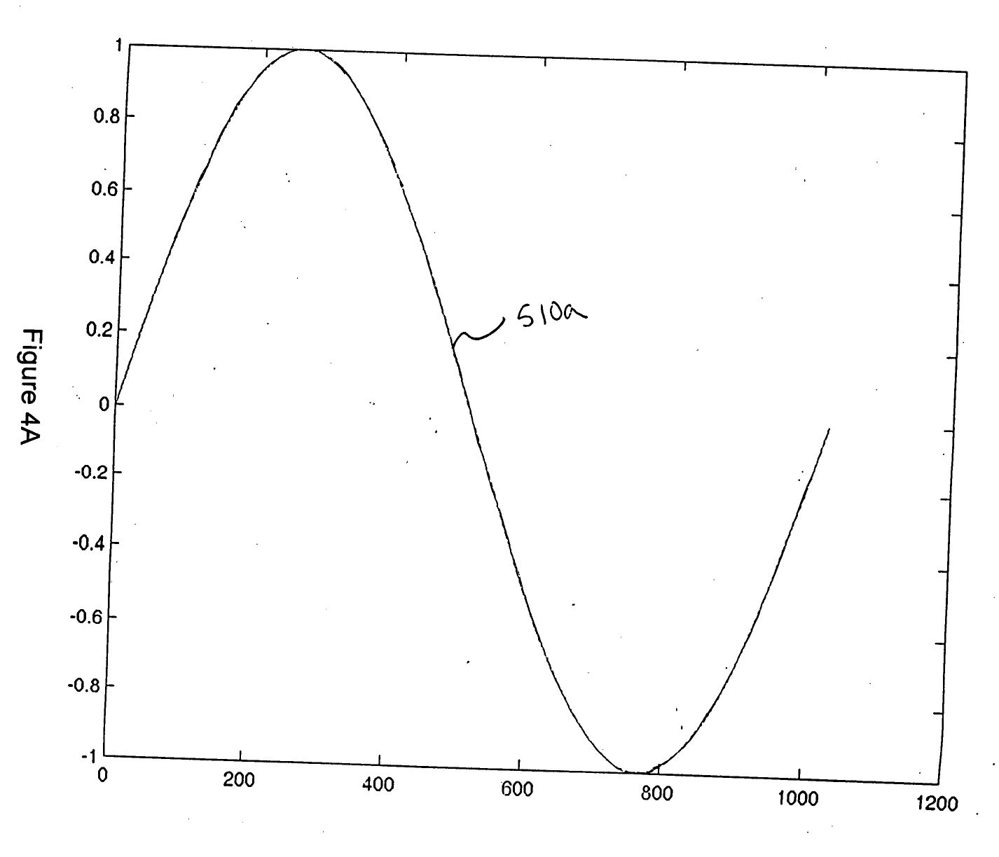

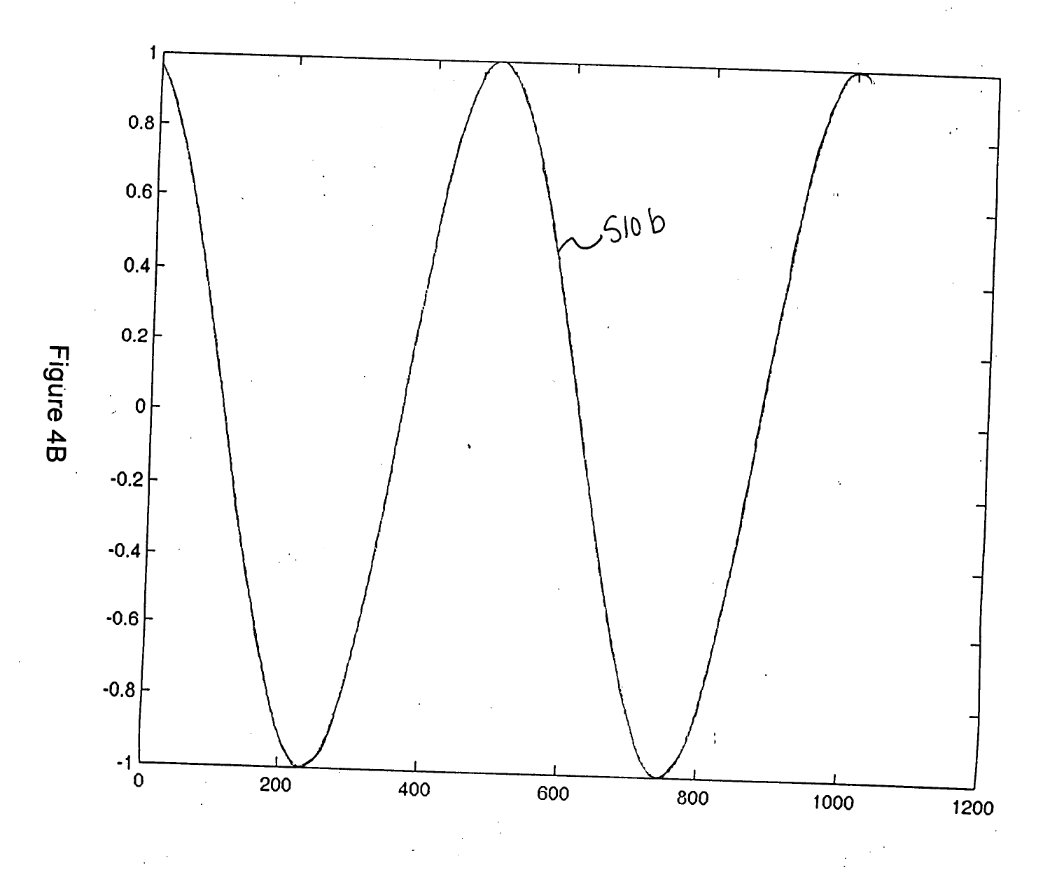

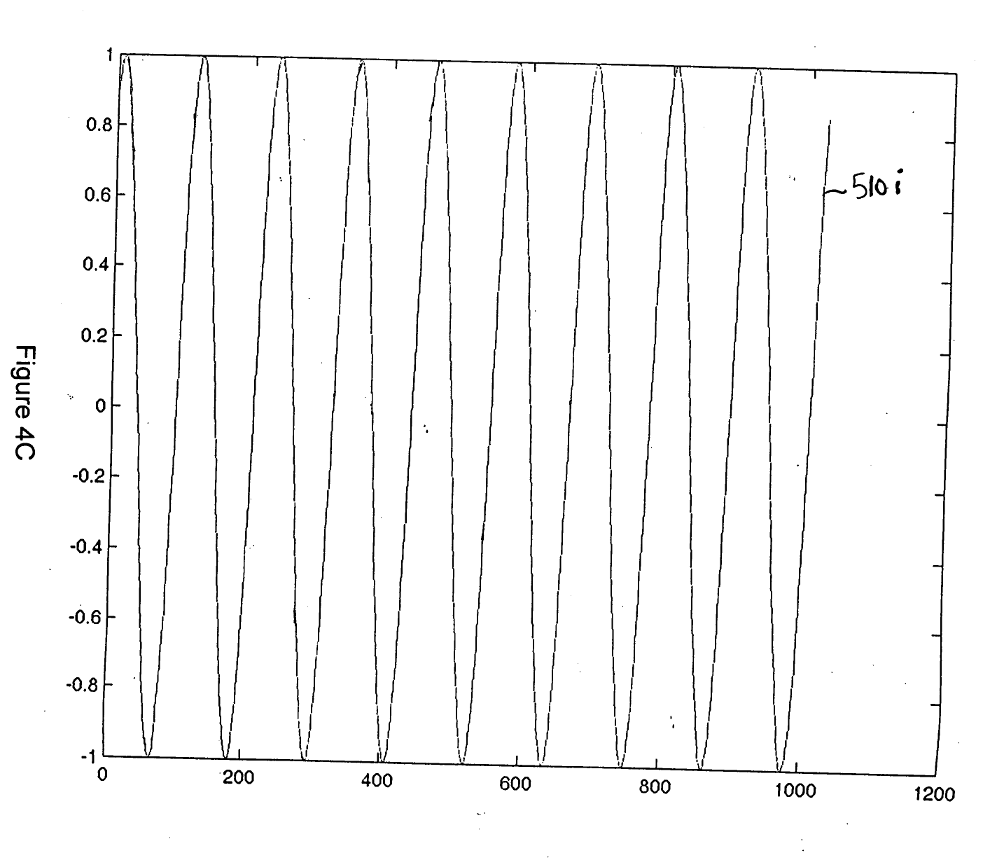

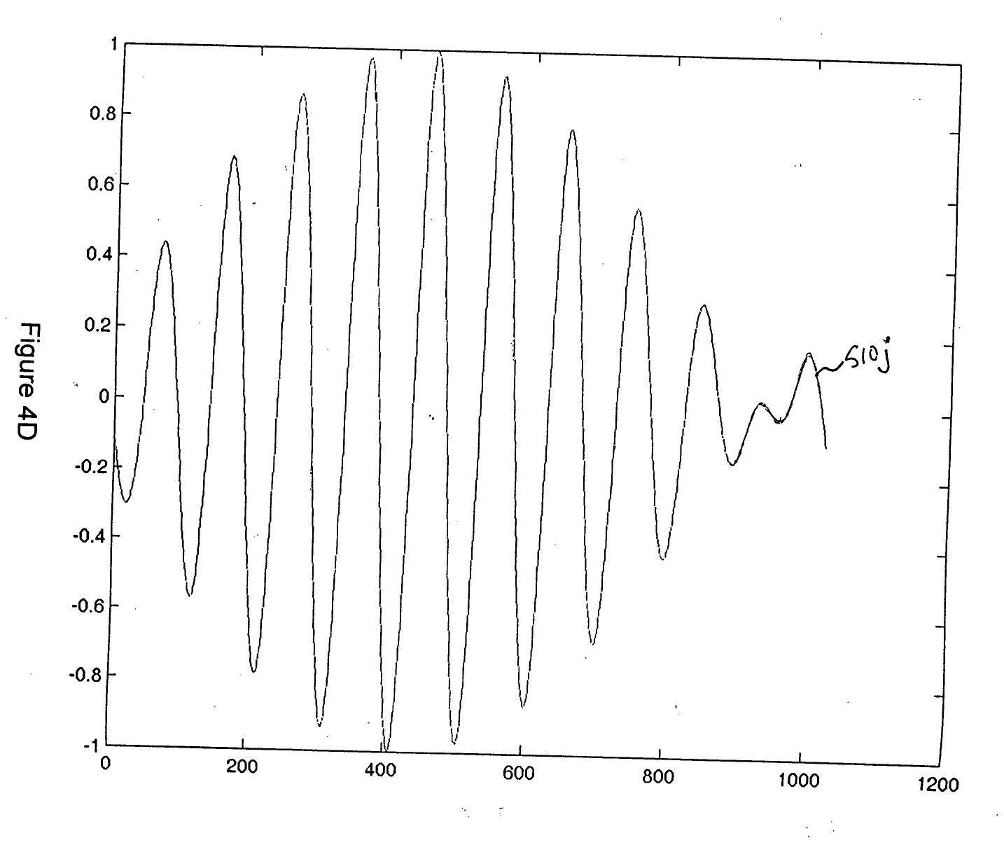

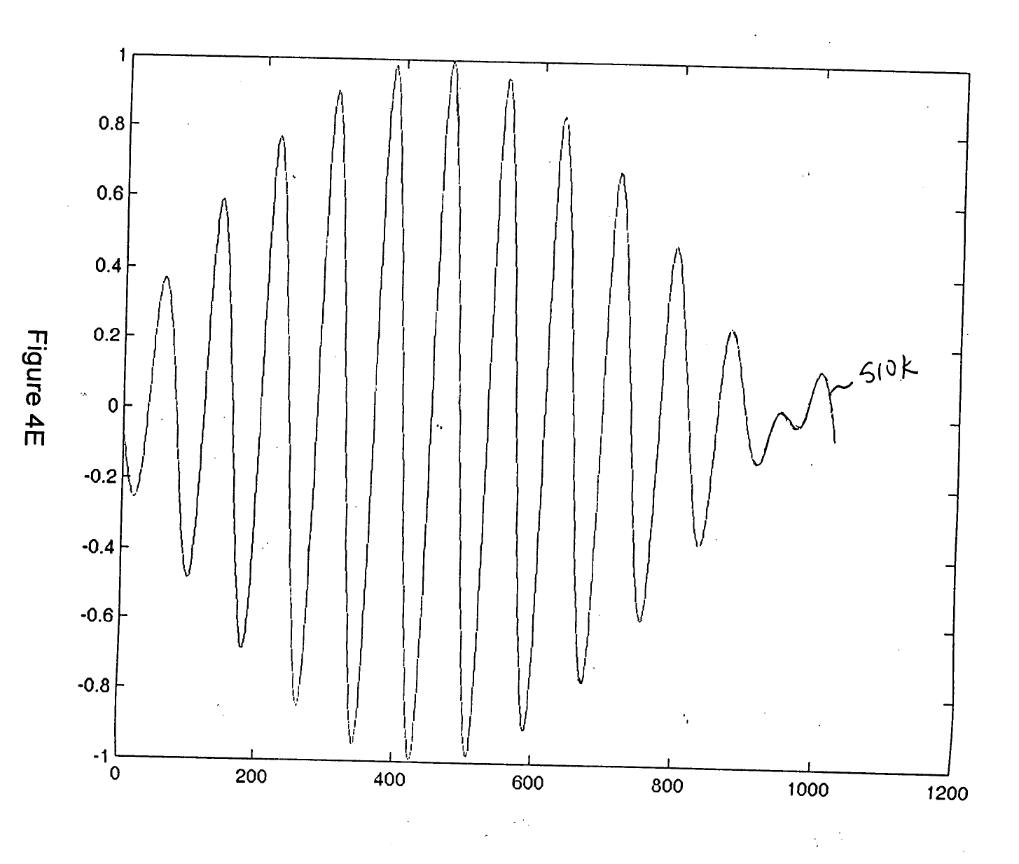

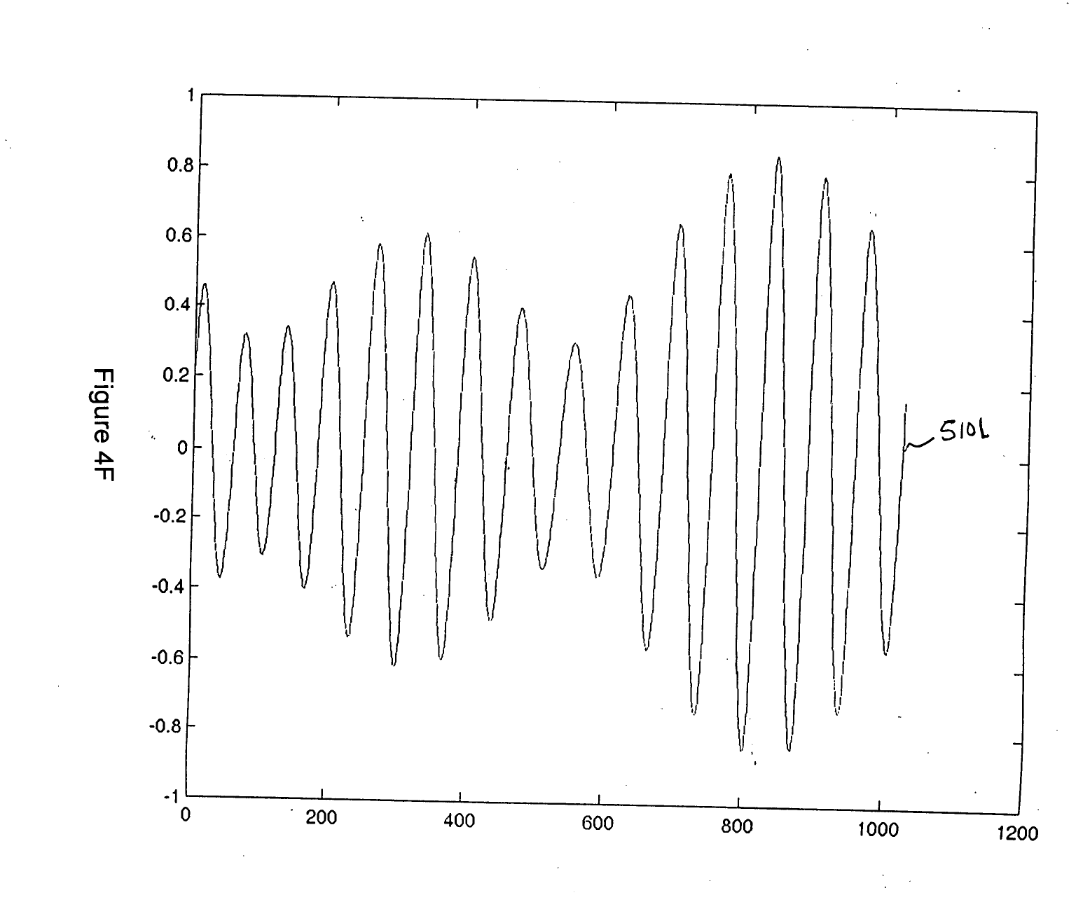

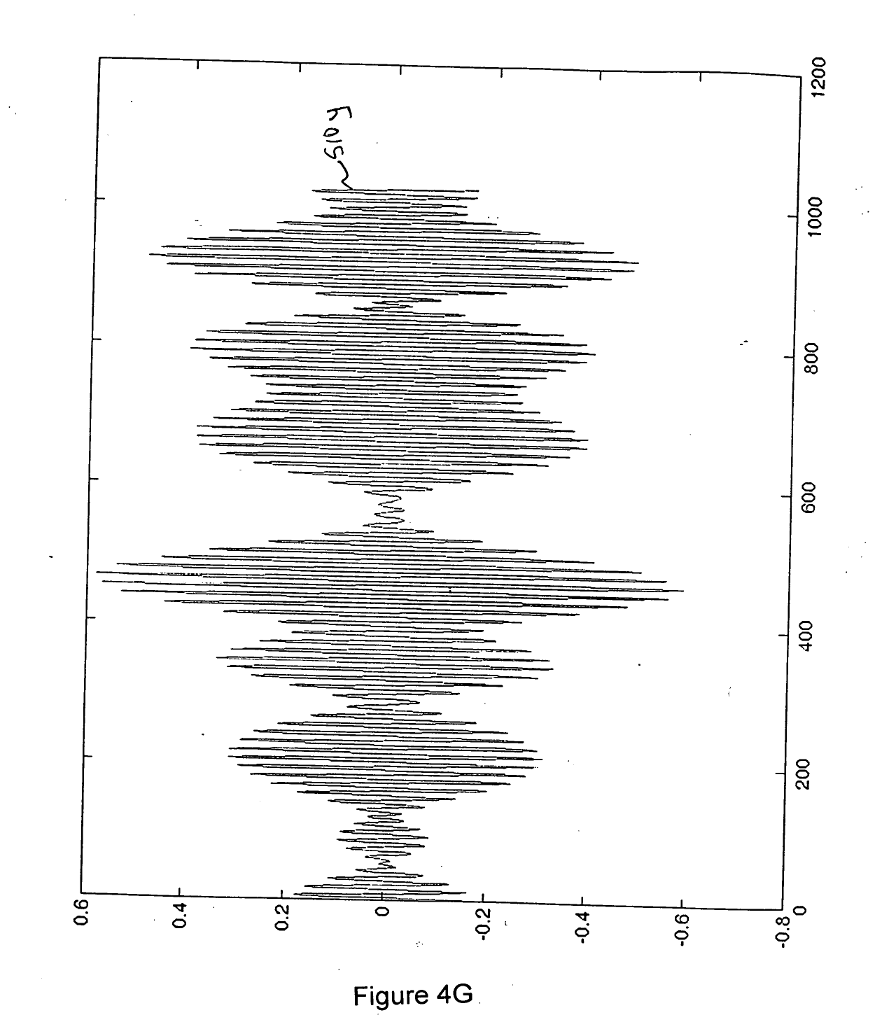

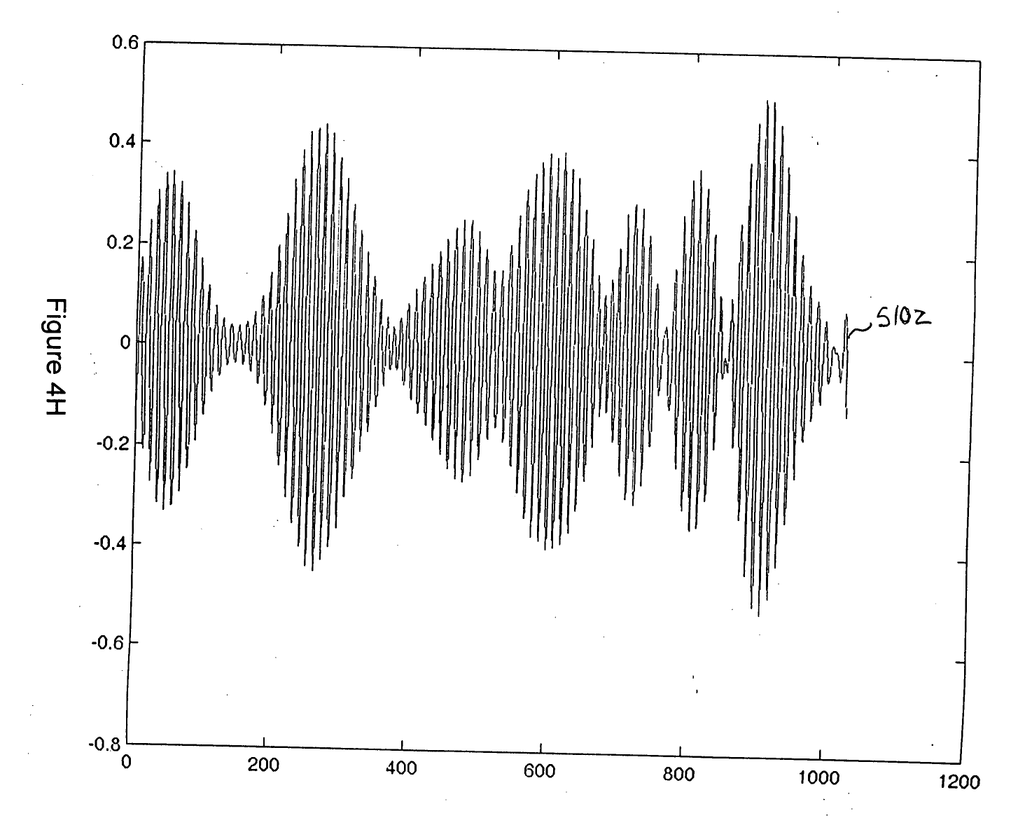

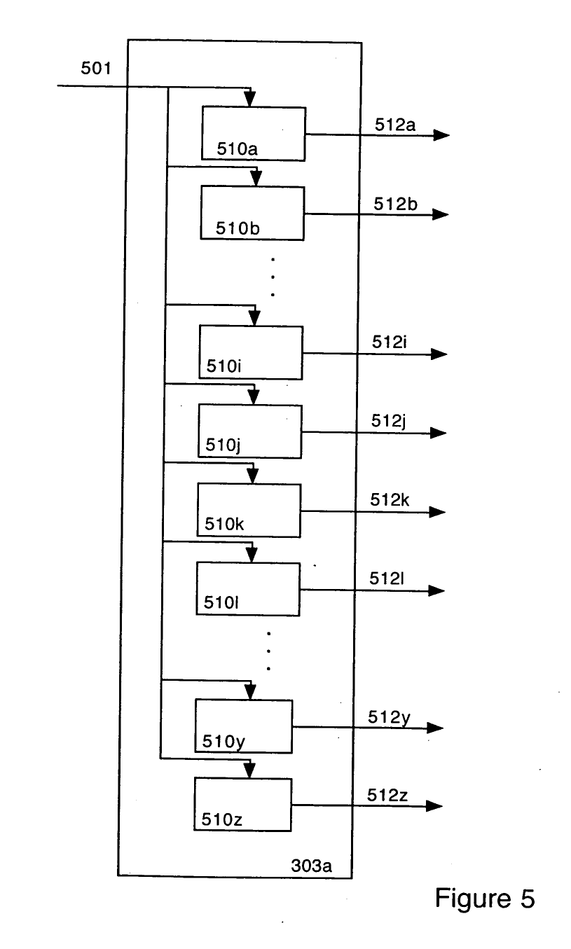

FIGS. 4A-4H are a representative portion of the waveforms stored in critical band tables for example embodiments (see FIGS. 5-8) of the present invention. This embodiment utilizes 24 tables. There are 101 total harmonics. Below is the range of harmonics in each table. A range like (3,3) means there's only the 2nd harmonic so it's a pure sine. A range like (42,48) means the table is the sum of 7 harmonics, the 42nd through the 48th.

As an example, 101 harmonics mean that a 100 Hz f0 tone (which is about an octave below middle C) will have harmonics up to about 10 kHz, which is reasonable for a tone of somewhat low pitch.

{1,1} this is f₀, and is shown in FIG. 4A as waveform 510a.

{2,2} is shown in FIG. 4B as waveform 510b.

{3,3} is not shown.

{4,4} is not shown.

{5,5} is not shown.

{6,6} is not shown.

{7,7} is not shown.

{8,8} is not shown.

{9,9} is shown in FIG. 4C as waveform 510i.

{10,11} is shown in FIG. 4D as waveform 510j.

{12,13} is shown in FIG. 4E as waveform 510k.

{14,16} is shown in FIG. 4F as waveform 510l.

{17,19} is not shown.

{20,22} is not shown.

{23,26} is not shown.

{27,30} is not shown.

{31,35} is not shown.

{36,41} is not shown.

{42,48} is not shown.

{49,56} is not shown.

{57,65} is not shown.

{66,75} is not shown.

{76,87} is shown in FIG. 4G as waveform 510y.

{88,101} is shown in FIG. 4H as waveform 510z.

In the preferred embodiment, the initial phases of the 101 harmonics (sines) is random. A range in the number of samples in each table from 1 k to 64 k works well. The number of samples chosen will depend upon the sound quality desired and the type of interpolation scheme employed.

FIG. 5 is a block diagram illustrating the table lookup/function generator portion of a second embodiment of the additive synthesizer of the present invention. This embodiment is very similar to that of FIG. 3, in that a single offset 501 (based upon current phase 322, derived from initial phase 320 and phase increment 324) is the same across all of the table lookup oscillators 510. Critical band signals 512 will have gains applied in gain block 305. Since a single offset 501 is used for all tables 510, it follows that the tables are the same length. An embodiment that is particularly efficient in terms of processing power interleaves the entries in the critical tables 510. This would mean that 24 samples in a row are read out, one from table 510a, one from table 510b, and so on through table 510y, rather than skipping around in memory.

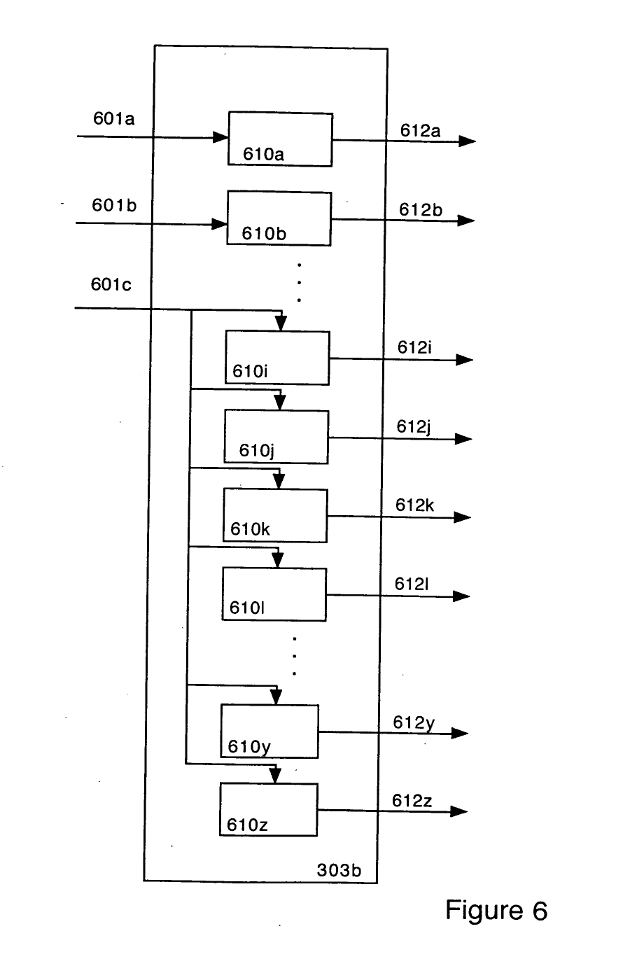

FIG. 6 is a block diagram illustrating the table lookup/function generator portion of a third embodiment of the additive synthesizer of the present invention. In the embodiment of FIG. 6, the first few harmonics are generated by functions generators 610a and 610b. The remaining harmonics are generated as shown in FIG. 5. Function generators 620a and 620b may be second order resonating filters, cordic signal generators, or any similar sinusoidal signal generator.

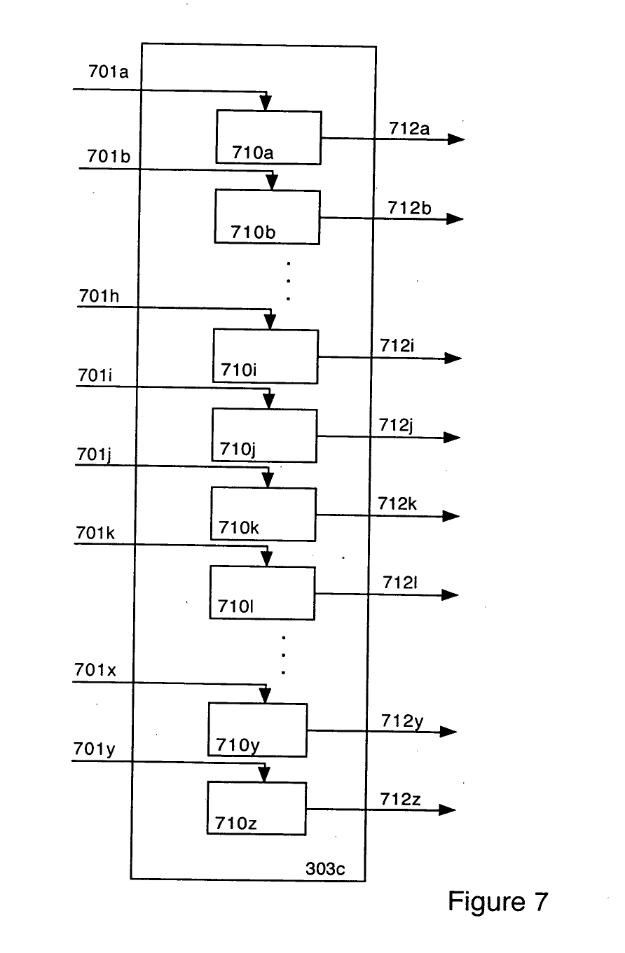

FIG. 7 is a block diagram illustrating the table lookup/function generator portion of a fourth embodiment of the additive synthesizer of the present invention. In the embodiment of FIG. 7, a different current phase 701 applied to at least some of the tables 710. This allows for randomized initial phase (if this has not been done in the tables themselves). In addition, different table lengths may be used. Detuning and generation of non-pitched tonal sounds is also possible in this embodiment. This is because if the tables are stepped through at different rates, the relationship between the frequencies of the harmonics can be changed.

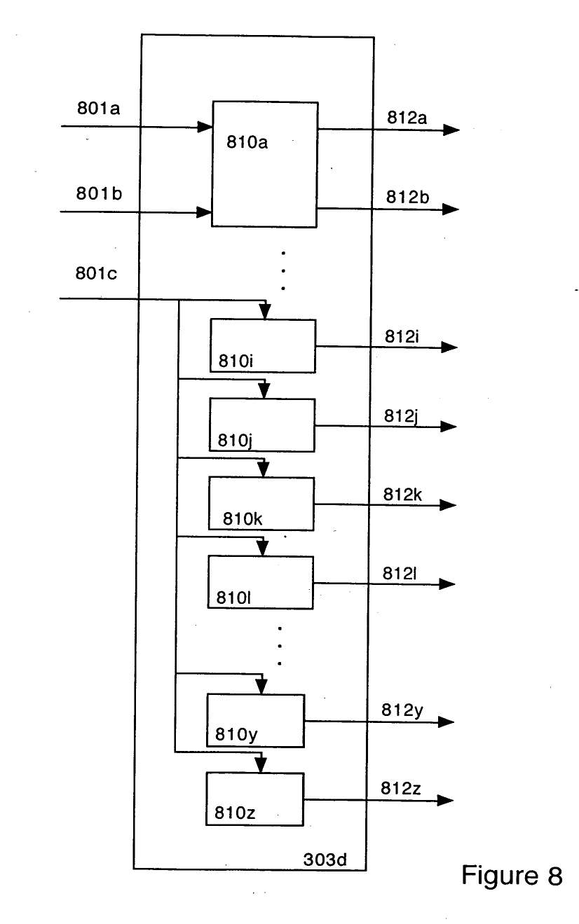

FIG. 8 is a block diagram illustrating the table lookup/function generator portion of a fifth embodiment of the additive synthesizer of the present invention. In the embodiment of FIG. 8, a single table lookup oscillator 810 is used to generate two harmonics, 812a and 812b. Different offsets 801a and 801b are used to step through the same table at different rates, resulting in two different harmonics. In the specific example of FIG. 8, the rest of the harmonics are generated as shown in FIG. 5.

Those skilled in the art will appreciate that the features of the embodiments of FIGS. 5-8 can be mixed and matched. For example, functions generators can be used wherever convenient (most often for a single sine or two added sines). Individual offsets can be used for none, all, or some of the tables. The same table may be used to generate any desired number of harmonics by the use of different offsets.

Also note that redundant sines may be included in the tables (so that the tables overlap). For example, the three highest sines included in one table may also be the three lowest sines in the next table. Generally, each sine has the same amplitude, but this can be adjusted if desired. For example, where tables overlap, the redundant sines may be reduced in amplitude. Or, lower amplitudes may be used for higher frequency sines.

Those skilled in the art of particle enumeration will appreciate that the figures and description of preferred embodiments are useful for illustrating the present invention, but that many other configurations are also within the spirit of the invention.

What is claimed is:

1. A method of synthesizing tonal audio signals from a control input stream comprising the steps of:
generating a series of N signals according to the control input stream, each signal comprising the combination of one or more sinusoidal harmonics having frequencies that fall within one of N frequency bands; wherein
lower frequency bands include fewer harmonics,
higher frequency bands include more harmonics, and
the number N of frequency bands approximates the number of Critical Bands resolvable by human hearing;
applying a single gain envelope to each signal; and
combining the signals to form an output tonal audio signal.

2. The method of claim 1 wherein N is between 8 and 50.

3. The method of claim 1 wherein N is between 20 and 30.

4. The method of claim 1 wherein N is 24.

5. The method of claim 1 wherein the lowest frequency band includes the frequency f0 of the tonal audio signal to be synthesized.

6. The method of claim 5 wherein the frequency bands are based on integer multiples of f0.

7. The method of claim 1 wherein the input control stream is MIDI.

8. The method of claim 1 wherein signals for at least some of the higher bands are generated from wavetables.

9. The method of claim 8 wherein the wavetables are table lookup oscillators.

10. The method of claim 8 wherein signals for at least some of the lower bands are generated from by function generators.

11. The method of claim 8, wherein the step of generating signals from wavetables further includes the step of applying an initial phase position and a phase increment within the wavetables, and wherein a single phase position and phase increment are used for all wavetables.

12. The method of claim 8, wherein the step of generating signals from wavetables further includes the step of applying an initial phase position and a phase increment within the wavetables, and wherein the initial phase is randomized among the wave tables.

13. The method of claim 8, wherein the same tables are used for more than one band by using different phase increments.

14. The method of claim 8, wherein the same tables are used for a variety of instruments.

15. The method of claim 8, wherein the table lengths are identical.

16. The method of claim 1 2, wherein the tables are interleaved.

17. The method of claim 1 5 wherein all the harmonics for a particular wavetable reside in one memory cache line.

18. The method of claim 1 wherein the lower bands contain one harmonic and are generated from function generators, and wherein higher bands contain combinations of harmonics and are generated from wavetables.

19. A method of synthesizing tonal audio signals from a MIDI control input stream comprising the steps of:
generating a series of N signals based upon the MIDI input, each signal comprising the combination of one or more harmonics having frequencies that fall within one of N frequency bands; wherein
lower frequency bands include fewer harmonics,
higher frequency bands include more harmonics, and
the number N of frequency bands is approximately 24, approximating the number of
Critical Bands resolvable by human hearing;
applying a single gain envelope to each signal; and
combining the signals to form an output tonal audio signal.

20. The method of claim 19 wherein the step of generating signals generates the signal associated with at least the lowest band via a function generator and generates the signals associated with at least some of the higher bands via wavetables.

21. The method of claim 19 wherein the step of generating signals generates at least some of the signals via wavetables, and wherein the same wavetables are used for a variety of instruments.
